(19) United States
(12) Patent Application Publication
(10) Pub. No.: US 2006/0165588 A1
(43) Pub. Date: Jul. 27, 2006

(54) Process for producing hydrogen including a water gas shift reaction

(76) Inventor: Bernard John Crewdson, N. Yorks (GB)

Correspondence Address: RATNERPRESTIA, P O BOX 980, VALLEY FORGE, PA, 19482-0980, US

(21) Appl. No.: 10/523,557

(22) PCT Filed: Jul. 30, 2003
(86) PCT No.: PCT/GB03/03212

§ 371 Date: Jul. 14, 2005

(30) Foreign Application Priority Data
Aug. 1, 2002 (GB) 0217801.0

(51) Int. Cl. C01B 3/16; C01B 3/18

(52) U.S. Cl. 423/656

(57) ABSTRACT

Production of a hydrogen-containing gas stream by subjecting a gas stream containing carbon monoxide and steam to the shift reaction using a shift catalyst containing, in the reduced state, at least 15% by weight of copper, wherein, immediately upstream of the shift catalyst, the gas stream is passed through a bed of an oxygen scavenger comprising an oxidisable composition containing copper and/or iron or iron oxide that is dissimilar to said shift catalyst.

The present invention relates to hydrogen and in particular to the production of hydrogen-containing gas streams. Such gas streams are often made by partial oxidation and/or steam reforming of a suitable carbonaceous feedstock, to produce a gas stream containing hydrogen and carbon oxides. In order to increase the hydrogen content and decrease the carbon monoxide content, the gas stream is then often subjected to the shift reaction wherein carbon monoxide is reacted with steam to produce carbon dioxide and hydrogen. Suitable carbonaceous feedstocks include hydrocarbons such as naphtha and natural gas and hydrocarbon derivatives, e.g. oxygen-containing compounds such as methanol or dimethyl ether.

The shift reaction may be effected using a copper-containing catalyst, often a composition containing copper, zinc oxide and carbon or one or more oxides selected from alumina, silica, rare earth oxides, chromia, zirconia, titania, iron oxide and magnesia.

One application of the above process is in the production of hydrogen streams for use as fuel for fuel cells, for example for mobile applications such as electrically powered vehicles. In such applications there is liable to be frequent shut-down and start-up of the hydrogen production process. It has been found that during such shut-downs, there is a risk that a small amount of air enters into the system and this is liable to oxidise and de-activate the copper-containing shift catalyst.

Although the oxidised copper species will generally be re-reduced to copper metal upon restart of the hydrogen production process by the action of the hydrogen present in the feed to the shift reactor, there is a risk that the shift activity will decrease significantly with time.

In the present invention this problem is overcome by employing a bed of an oxygen scavenger immediately upstream of the shift catalyst. By “immediately upstream” we mean that there is no process step, e.g. heating or cooling, to which the process gas is subjected after passage through the bed of oxygen scavenger and before entering the shift catalyst.

Accordingly the present invention provides a process for the production of a hydrogen-containing gas stream including the shift reaction wherein a gas stream containing carbon monoxide and steam is passed through a bed of a shift catalyst containing, in the reduced state, at least 15% by weight of copper, characterised in that, immediately upstream of said shift catalyst, the gas stream is passed through a bed of an oxygen scavenger comprising an oxidisable composition containing copper and/or iron or iron oxide that is dissimilar to said shift catalyst.

The oxygen scavenger may itself be a shift catalyst e.g. a reduced iron oxide/chromia composition, optionally also containing copper, or be a copper-containing composition exhibiting some shift activity. In this case there will be in effect two or more beds of shift catalyst of differing compositions with the inlet bed acting primarily as the oxygen scavenger.

It has been proposed in WO 00/17096 to have a bed of a copper-containing shift catalyst upstream of an iron oxide-containing shift catalyst. In that reference the purpose of the copper-containing shift catalyst bed was to effect some shift reaction before the gas stream encountered the iron oxide-containing shift catalyst in order to avoid reaction conditions conducive to over-reduction of the iron oxide-containing shift catalyst: That reference also discloses that, after passage through the iron oxide containing shift catalyst, the process gas may be cooled and then subjected to the low temperature shift reaction using a conventional low temperature shift catalyst. In contrast thereto, in the present invention, the oxygen scavenger bed is immediately upstream of the copper-containing shift catalyst, i.e. there is no cooling of the process gas after it has passed through the oxygen scavenger bed and before it enters the copper-containing shift catalyst.

The oxygen scavenger will normally be in the reduced state during normal operation of the hydrogen-producing process and will oxidise in the event of ingress of air during or after a shut-down procedure. Upon re-start of the hydrogen production, the scavenger will generally be re-reduced and so regenerated in readiness for the next shut-down.

The oxygen scavenger composition may be a bed of a high copper content composition such as a methanol synthesis catalyst, e.g. a composition containing copper and one or more stabilising oxides such as zinc oxide, alumina, magnesia, chromia, zirconia, titania or rare earth oxides and containing at least 50% by weight of copper when in the reduced state. Such materials generally have a relatively high copper surface area per gram of catalyst and so have a high capacity for absorbing oxygen. The high surface area agglomerates described in U.S. Pat. No. 4,871,710 and made by agglomerating co-precipitated copper, zinc and aluminium compounds may, after reduction, also be used as the copper-containing oxygen scavenger. Yet another copper-containing oxygen scavenger that may be used is the product of reducing the alunina/copper carbonate agglomerates described in U.S. Pat. No. 5,853,681. Alternatively copper supported on carbon or silica may be employed.

However high copper-content compositions having a high copper surface area (e.g. above about 40 m² per gram of the reduced scavenger composition) may lack adequate physical strength to withstand repeated oxidation/reduction cycles in some applications.

In such a case it may be desirable to employ a copper-containing composition of greater physical strength. Thus a suitable support having the desired physical strength may be impregnated or coated with a composition containing a suitable copper species: the coated or impregnated support is subsequently subjected to a reduction step to convert the copper species to metallic copper. In a preferred system however, the oxygen scavenger is the product of reducing a precursor comprising copper compounds supported on shaped units of a material such as alumina or a calcium aluminate cement. Such a precursor may be produced by impregnating the support with a solution of a thermally decomposable copper compound, and optionally other components such as zinc, magnesium, aluminium and/or chromium compounds, followed by calcination of the impregnated support to decompose the copper compound, and possibly other components, to the oxidic state. Alternatively the support material may be coated with a slurry of precipitated, thermally decomposable, copper compounds, and possibly other components as aforesaid, dried, and then calcined to convert the thermally decomposable compounds to the oxidic form. Preferably such oxygen scavengers, after reduction, contain 3 to 15% by weight of copper. The oxygen scavenger may be in the form of a random packed bed of pellets of the support, which may be a macroporous foam as described in U.S. Pat. No. 4,810,685, or monolithic, e.g. a honeycomb or a macroporous foam as aforesaid, to which the catalytic material has been applied, for example by impregnation or coating. One method of forming suitable impregnated oxygen scavengers involves impregnating a transition alumina support with an ammoniacal copper carbonate complex followed by heating to decompose that complex.

The shift catalyst contains, in the reduced state, at least 15% by weight of copper and typically comprises the product of reducing pellets formed from a calcined composition of co-precipitated copper, zinc and aluminium and/or chromium compounds, e.g. oxides, hydroxides or basic carbonates. Often such catalysts (in the reduced state) contain 20-50% by weight of copper. Other components such as magnesium or manganese compounds may be incorporated.

The oxygen scavenger and/or shift catalyst may be charged to the reactor in which the process is to be effected as precursors in the oxidised state and then reduced in situ. The reduction may be effected using the process gas, e.g. from steam reforming, as the gas used to effect reduction. However there is a risk that this will result overheating of the copper-containing shift catalyst and hence loss of activity thereof. Reduction using a gas stream containing only a small proportion of hydrogen, e.g. less than 10% by volume of hydrogen is therefore preferred. Since this may be inconvenient for some applications, e.g. where the shift reactor is part of a mobile unit, it may be preferable to employ a pre-reduced shift catalyst. U.S. Pat. No. 5,928,985 describes a process, using carbon dioxide and oxygen, to effect passivation of copper catalysts. After charging the pre-reduced and passivated shift catalyst, the latter can be re-reduced to the active state using the hydrogen-containing process gas without undue heating of the catalyst. Upon shut-down the oxygen scavenger acts to minimise the oxidation of the shift catalyst and so re-reduction of the latter thereafter is unnecessary and/or can be effected with the process gas without undue overheating. Furthermore, providing the proportion of oxygen scavenger employed is relatively small, re-reduction of the latter after a shut down can be effected with the process gas without undue overheating. Also, if the oxygen scavenger contains a relatively small proportion of copper on a support, the support acts as a heat sink to minimise the risk of overheating, thus enabling reduction to be effected with the process gas.

The amount of oxygen scavenger employed in relation to the amount of shift catalyst will depend upon the nature of the oxygen scavenger and the expected amount of oxygen ingress. Preferably the volume of oxygen scavenger is 5 to 20%, preferably 5 to 10%, of the volume of the shift catalyst.

The shift process is preferably effected at a pressure in the range 1 to 30 bar abs and at an inlet temperature in the range 120° C. to 280° C., particularly 150° C. to 250° C. Heat evolved in the shift reaction may be recovered and used to provide heat required elsewhere in the hydrogen production process, e.g. for pre-heating the feedstock and/or for providing steam required for reforming.

In a typical fuel cell application, the shift stage will form part of a hydrogen production train including partial oxidation and/or steam reforming of a suitable feedstock as indicated above. The shift stage will normally be followed by a stage of selective oxidation of any residual carbon monoxide. If the fuel cell is of a type that is de-activated by carbon dioxide, a step of carbon dioxide removal will be employed after the shift stage. In this case residual carbon oxides can be removed by methanation and selective oxidation of the carbon monoxide is then not necessary.

1. A process for the production of a hydrogen-containing gas stream including the shift reaction wherein a gas stream containing carbon monoxide and steam is passed through a bed of a shift catalyst containing, in the reduced state, at least 15% by weight of copper, wherein, immediately upstream of said shift catalyst, the gas stream is passed through a bed of an oxygen scavenger comprising an oxidisable composition containing copper and/or iron or iron oxide that is dissimilar to said shift catalyst.

2. A process according to claim 1 wherein the shift catalyst, in the reduced state, contains 20 to 50% by weight of copper.

3. A process according to claim 1 or claim 2 wherein the oxygen scavenger, in the reduced state, contains at least 50% by weight of copper.

4. A process according to claim 1 or claim 2 wherein the oxygen scavenger comprises the product of reducing copper compounds supported on shaped units formed from alumina or a calcium aluminate cement.

5. A process according to claim 4 wherein the oxygen scavenger, after reduction, contains 3 to 15% by weight of copper.

6. A process according to claim 1 or claim 2 wherein the volume of oxygen scavenger is 5 to 20% of the volume of the shift catalyst.

7. An apparatus for the production of a hydrogen-containing gas stream including a shift reactor comprising a bed of a shift catalyst containing, in the reduced state, at least 15% by weight of copper, wherein, immediately upstream of said shift reactor, there is a bed of an oxygen scavenger comprising an oxidisable composition containing copper and/or iron or iron oxide that is dissimilar to said shift catalyst.

8. An apparatus according to claim 7 wherein the shift catalyst, in the reduced state, contains 20 to 50% by weight of copper.

9. An apparatus according to claim 7 or claim 8 wherein the oxygen scavenger, in the reduced state, contains at least 50% by weight of copper.

10. An apparatus according to claim 7 or claim 8 wherein the oxygen scavenger comprises the product of reducing copper compounds supported on shaped units formed from alumina or a calcium aluminate cement.

11. An apparatus according to claim 10 wherein the oxygen scavenger, after reduction, contains 3 to 15% by weight of copper.

12. An apparatus according to claim 7 or claim 8 wherein the volume of oxygen scavenger is 5 to 20% of the volume of the shift catalyst.
